(19) United States
(12) Patent Application Publication
(10) Pub. No.: US 2007/0202141 A1
(43) Pub. Date: Aug. 30, 2007

(54) Synthetic Aggregation Pheromone For Manipulating The Behaviour Of Codling Moth, Cydia Pomonella, Larvae

(75) Inventors: Zaid Jumean, Sarnia (CA); Regine Gries, Coquitlam (CA); Gerhard Gries, Coquitlam (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: PHERO TECH INC., Delta, BC (CA)

(21) Appl. No.: 10/599,711

(22) PCT Filed: Apr. 6, 2005
(86) PCT No.: PCT/CA05/00522

§ 371 Date: Feb. 27, 2007

Related U.S. Application Data
(60) Provisional application No. 60/559,452, filed on Apr. 6, 2004.

(51) Int. Cl. A01N 25/34; A01N 35/00; A01N 27/00

(52) U.S. Cl. 424/416; 514/675; 514/693; 514/762

(57) ABSTRACT

This invention relates to a composition and procedure for manipulating the behaviour of codling moth larvae, Cydia pomonella (L.) (Lepidoptera: Olethreutidae). In particular, this invention relates to the use of specific pheromone components for manipulating the behaviour of C. pomonella larvae. A composition of chemicals for manipulating the behaviour of Cydia pomonella larvae, said composition comprising two or more chemicals in all possible combinations and ratios selected from the group consisting of: 1) heptanal; 2) 6-methyl-5-hepten-2-one (sulcatone); 3) myrcene; 4) octanal; 5) 3-carene; 6) (+)-limonene; 7) (E)-2-octenal; 8) nonanal; 9) (E)-2-nonenal; 10) decanal; 11) geranylacetone.

### FIELD OF THE INVENTION

This invention relates to a composition and procedure for manipulating the behaviour of codling moth larvae, Cydia pomonella (L.) (Lepidoptera: Olethreutidae). In particular, this invention relates to the use of specific pheromone components for manipulating the behaviour of C. pomonella larvae.

### BACKGROUND OF THE INVENTION

Larvae of the codling moth, Cydia pomonella (L.) (Lepidoptera: Olethreutidae), feed on and cause damage to apple, pear, walnut and other fruit and nut crops. In a typical apple orchard, if left untreated, C. pomonella larvae can infest up to 95% of the crop resulting in major economic loss.

In temperate regions, larvae feed from June to August within (apple) fruits. In August, larvae exit fruits and seek pupation sites, often on trunks of fruit-bearing trees. Spinning cocoons in which to pupate, larvae produce an aggregation pheromone that attracts or arrests other C. pomonella larvae (Duthie et al. 2003; Jumean et al. 2004a, 2005). Components of this aggregation pheromone also attract the parasitic wasp Mastrus ridibundus (Hymenoptera: Ichneumonidae) (Jumean et al. 2004b) which parasitize C. pomonella prepupae inside cocoons. Synthetic aggregation pheromone in trapping devices would allow behavioural manipulation of C. pomonella larvae.

There are several patents listed in the United States Patent and Trademark Office database under the keyword Cydia pomonella. Two patents are concerned with the synthesis of attractants for C. pomonella, as follows: U.S. Pat. No. 3,943,157 “Synthesis of codling moth attractant” reports the synthesis of codling moth sex pheromone, and U.S. Pat. No. 5,599,848 “Preparation, intermediates for the preparation and use of a mixture of dodecadienol isomers” reports a process for preparing and using the mixture of 8E, 10E-dodecadienol, 8E,10Z-dodecadienol, 8Z,10E-dodecadienol, and 8Z,10Z-dodecadienol for interference of mating of C. pomonella adults. Three additional patents are concerned with methods of interfering with mating of C. pomonella adults, as follows: U.S. Pat. No. 6,395,775 “Combating pest insects” reports the use of the sex pheromone E8,E10-dodecadien-1-ol in combination with one or more behavioural antagonists or behavioural synergists for C. pomonella control. U.S. Pat. No. 4,734,281 “Method for concurrently emitting vapours of sex pheromones of different insects” reports the use of sex pheromone dispensers for controlling the population of two or more species' of insect pests in the field, including C. pomonella. Finally, U.S. Pat. No. 6,528,049 “Bisexual attractants, aggregants, and arrestants for adult and larvae of codling moth and other species of lepidoptera” reports a method for monitoring and control of C. pomonella using attractants and arrestants from pears or apples. All of the behaviour-modifying compounds claimed for control of C. pomonella in the patents referred to above are very different from the attractive pheromone components produced by C. pomonella larvae, claimed in this application for attraction or arrestment of C. pomonella larvae that forage for suitable pupation sites.

### SUMMARY OF THE INVENTION

We have discovered pheromone components which attract or arrest male and female C. pomonella larvae. These pheromone components are derived from silk produced when either male of female larvae spin cocoons.

The invention is directed to the preparation and implementation of these pheromone components for manipulating the behaviour of C. pomonella larvae. The pheromone components can be used in all possible combinations and ratios. The pheromone component compositions can be contained in slow release devices. The devices can be held in traps to retain male and female C. pomonella larvae. The invention can be used in combination with other tactics employed to control C. pomonella adults for protection of apple, pear, walnut, and other fruit and nut crops from C. pomonella.

The invention is also directed to a composition of chemicals for manipulating the behaviour of C. pomonella larvae, said composition comprising pheromone components in all possible combinations and ratios selected from the group consisting of: 1) heptanal; 2) 6-methyl-5-hepten-2-one (sulcatone); 3) myrcene; 4) octanal; 5) 3-carene; 6) (+)-limonene; 7) (E)-2-octenal; 8) nonanal; 9) (E)-2-nonenal; 10) decanal; and 11) geranylacetone.

The composition can be contained in, or released from, slow release devices. The composition can be contained in, or released from, a trap that captures attracted C. pomonella larvae.

The invention is also directed to an apparatus for attracting or arresting C. pomonella larvae, said apparatus containing a composition comprising pheromone components in all possible combinations and ratios selected from the group consisting of: 1) heptanal; 2) sulcatone; 3) myrcene; 4) octanal; 5) 3-carene; 6) (+)-limonene; 7) (E)-2-octenal; 8) nonanal; 9) (E)-2-nonenal; 10) decanal; and 11) geranylacetone.

The invention is also directed to a bait and apparatus for deployment in orchards and on trees susceptible to C. pomonella and in fruit and nut harvest bins where C. pomonella reside, said bait incorporating pheromone components in all possible combinations and ratios and an apparatus which is suitable for C. pomonella larvae to pupate in.

The invention also pertains to a method of manipulating the behaviour of C. pomonella larvae which comprises exposing the insects to one or more pheromone components according to the invention.

The invention also pertains to a method of diagnosing whether protection of an apple, pear, walnut or other fruit or nut crop is warranted, comprising exposing apple, pear, walnut, or other fruit or nut crops to a composition of two or more pheromone components according to the invention, and determining whether any C. pomonella larvae are attracted or arrested by the composition of pheromone components.

The invention also includes a method of protecting apple, pear, walnut, or other fruit or nut crops from attack by C. pomonella larvae by deploying proximate to apple or pome fruit crops the composition of pheromone components according to the invention. The composition of pheromone components can be combined with non-pheromonal attractants of larvae.

The composition can be contained in, and released from, an apparatus or matrix that can provide suitable pupation sites for attracted Cydia pomonella larvae. The apparatus can be corrugated cardboard. The apparatus can be a matrix that can polymerize and harden after application.

The apparatus or matrix can contain an insect-killing agent. The killing agent can be a chemical insecticide or a biological insecticide.

The two or more chemicals of the invention can be combined with a carrier.

### DRAWINGS

Drawings illustrate specific embodiments of the invention, but should not be construed as restricting the spirit or scope of the invention in any way:

FIG. 1 illustrates graphical data of responses of male or female Cydia pomonella larvae to pitfall devices baited with 1-day-old C. pomonella cocoons containing a male or female C. pomonella larva/prepupa.

FIG. 2 illustrates flame ionization detector (FID) and electroantennographic detector (EAD, female Mastrus ridibundus antenna) responses to ten cocoon-spinning Cydia pomonella larvae hour equivalents of cocoon volatile extracts.

FIG. 3 illustrates graphical data of responses of Cydia pomonella larvae to pitfall devices baited with natural or synthetic pheromone components from cocoon spinning C. pomonella larvae.

FIG. 4 illustrates graphical data of responses of Cydia pomonella larvae to pitfall devices baited with a synthetic 11-component pheromone blend at various doses.

FIG. 5 illustrates graphical data of responses of Cydia pomonella larvae to pitfall devices baited with synthetic pheromone blends lacking specific classes of pheromone components.

FIG. 6 illustrates graphical data of responses of Cydia pomonella larvae to pitfall devices baited with synthetic pheromone blends lacking individual pheromone components or specific groups of pheromone components.

FIG. 7 illustrates graphical data of responses of Cydia pomonella larvae to pitfall devices baited with various blends of synthetic pheromone components.

FIG. 8 illustrates graphical data of responses of Cydia pomonella larvae to pitfall devices baited with a synthetic 11-component pheromone blend, with components at natural ratios or increased amounts (×10) of specific components.

FIG. 9 illustrates graphical data of responses of Cydia pomonella larvae in on-tree experiments to corrugated cardboard bands baited with live C. pomonella larvae/prepupae or synthetic pheromone blends.

FIG. 10 illustrates graphical data of responses of Cydia pomonella larvae in on-tree experiments to corrugated cardboard bands baited with synthetic pheromone blends at various doses.

FIG. 11 illustrates graphical data of responses of Cydia pomonella larvae in on-tree experiments to corrugated cardboard bands baited with synthetic pheromone blends, with specific components increased (×10).

FIG. 12 illustrates graphical data of responses of Cydia pomonella larvae in on-tree experiments to corrugated cardboard bands baited with synthetic pheromone blends, with components at natural ratios or increased amounts (×10) of specific components.

FIG. 13 illustrates graphical data obtained in an apple orchard of mean (±SEM) numbers of Cydia pomonella larvae captured in prototype traps affixed to trees and baited with the 8-component synthetic pheromone blend or left unbaited.

FIG. 14 illustrates graphical data obtained in an apple orchard of mean (±SEM) numbers of Cydia pomonella larvae captured in prototype traps affixed to trees and baited with the 8-component synthetic pheromone blend at various doses.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

1. Response of Male and Female Cydia pomonella Larvae to Cocoon-Spinning Male or Female Larvae

Response of 5^{th} instar C. pomonella larvae seeking pupation sites was tested in 2-choice Petri dish olfactometers (Duthie et al., 2003), with modified Eppendorf tubes in pitfall devices preventing physical contact of larvae with test stimuli. For each of at least 30 replicates per experiment, one male or female larva was released in the center of the olfactometer, and its pupation site recorded 18-24 hours later. Test stimuli consisted of a control corrugated cardboard (CB) strip (2.5×2.5 cm) or a treatment CB strip carrying five 1-day-old cocoons each containing either a male or female C. pomonella larva/prepupa.

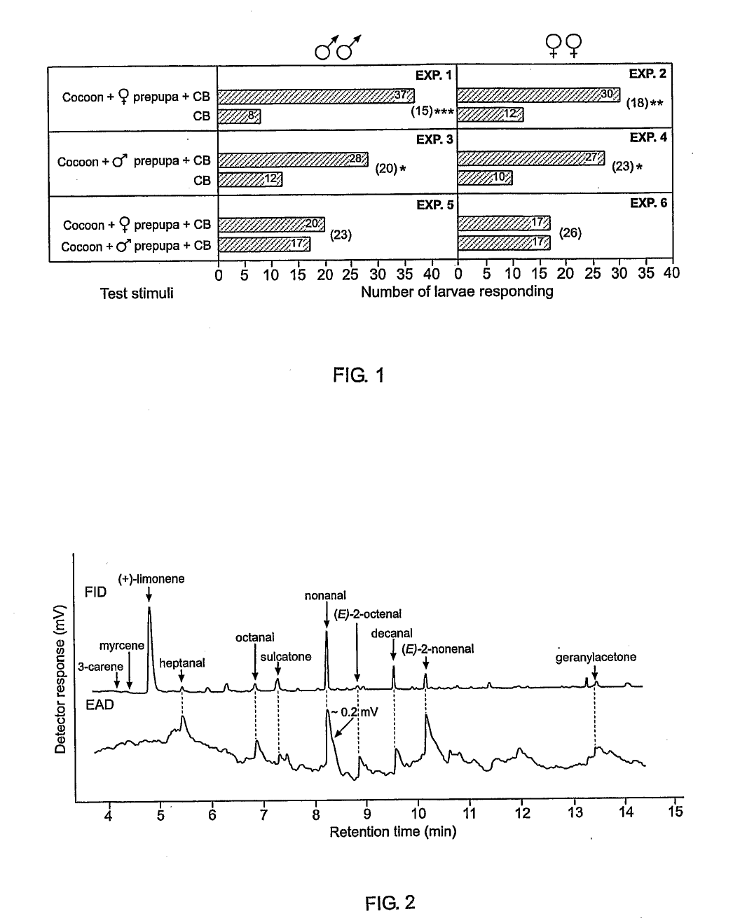

Male and female C. pomonella larvae preferred to spin cocoons in pitfall devices baited with CB carrying five 1-day-old cocoons, with no preference for cocoons containing either male or female larvae/prepupae (FIG. 1).

FIG. 1 illustrates graphical data of responses of male or female Cydia pomonella larvae to pitfall devices baited with control corrugated cardboard (CB) strips or treatment CB strips carrying five 1-day-old cocoons containing either male or female C. pomonella larvae/prepupae. Asterisks on bars indicate a significant response to a particular treatment; Chi-square goodness of fit test with Yates' correction for continuity; * P<0.025; ** P<0.001.

2. Acquisition, Analyses and Bioassays of Pheromone Components Produced by Cocoon-Spinning Cydia pomonella Larvae

To capture airborne pheromone components from cocoon-spinning larvae, three-hundred 5^{th} instar male and female larvae were placed in a cylindrical Pyrex glass chamber (15.5×20 cm). An empty chamber served as control. A water aspirator drew charcoal-filtered air at ˜2 l/min through each chamber and through a glass column (140×1.3 mm OD) containing Porapak Q (50-80 mesh, Waters Associates, Inc., Milford, Mass. 01757). After 72 hours, the filters were desorbed with 3 ml of pentane and ether (95:5). Extracts were concentrated under a nitrogen stream so that 1 μL was equivalent to ca. 10 cocoon-spinning larvae hour equivalents (10 CSLHE=volatiles released from 10 cocoon-spinning C. pomonella larvae during 1 hour).

Aliquots of 20 CSLHE of Porapak Q-captured volatiles were subjected to analysis by coupled gas chromatographic-electroantennographic detection (GC-EAD) (Arm et al. 1975) using an antenna of Mastrus ridibundus, a specialist parasitic wasp of C. pomonella prepupae, as the electroantennographic detector. Using antennae from female M. ridibundus, instead of C. pomonella larvae, in these analyses was necessary because the antennae of C. pomonella larvae are too small for electrophysiolocial studies. It was also justified because host-seeking female M. ridibundus respond to the pheromone produced by cocoon-spinning C. pomonella larvae. In these GC-EAD analyses, 10 components (8 visible in FIG. 2) elicited responses from M. ridibundus antennae.

FIG. 2 illustrates flame ionization detector (FID) and electroantennographic detector (EAD: female Mastrus ridibundus antenna) responses to 10 CSLHE of Porapak Q extract. Chromatography: Hewlett Packard (HP) 5890A gas chromatograph equipped with a fused silica column (30 m×0.32 mm ID) coated with DB-23 (J & W Scientific, Folsom, Calif. 95630, USA); linear flow velocity of carrier gas: 35 cm/sec; injector and FID detector temperature: 240° C.; temperature program: 1 min at 50° C., 10° C./min to 220° C. Full scan electron impact (E1) and chemical ionization (CI) mass spectra of EAD active compounds were obtained by GC-mass spectrometry (MS) using a Varian Saturn II Ion Trap GC-MS and a HP 5985B GC-MS, respectively, each fitted with the DB-210 or DB-5 column. Candidate pheromone components were identified as follows: 1. heptanal (0.85); 2. 6-methyl-5-hepten-2-one (sulcatone) (0.81); 3. myrcene (0.84); 4. octanal (0.94); 5. 3-carene (0.95); 6. (+)-limonene (13.00); 7. (E)-2-octenal (0.41); 8. nonanal (4.10); 9. (E)-2-nonenal (1.00); 10. decanal (1.40); 11. geranylacetone (0.50). Note: 1) 10 CSLHE=volatiles released from 10 cocoon-spinning larvae during 1 hour; 2) number in brackets refers to nanogram quantities present in 10 CSLHE; 3) (+)-limonene was not antenally active but was included in bioassay experiments as the most abundant component in extracts.

3. Response of Cydia pomonella Larvae to Blends of Natural or Synthetic Candidate Pheromone Components in Olfactometer Experiments

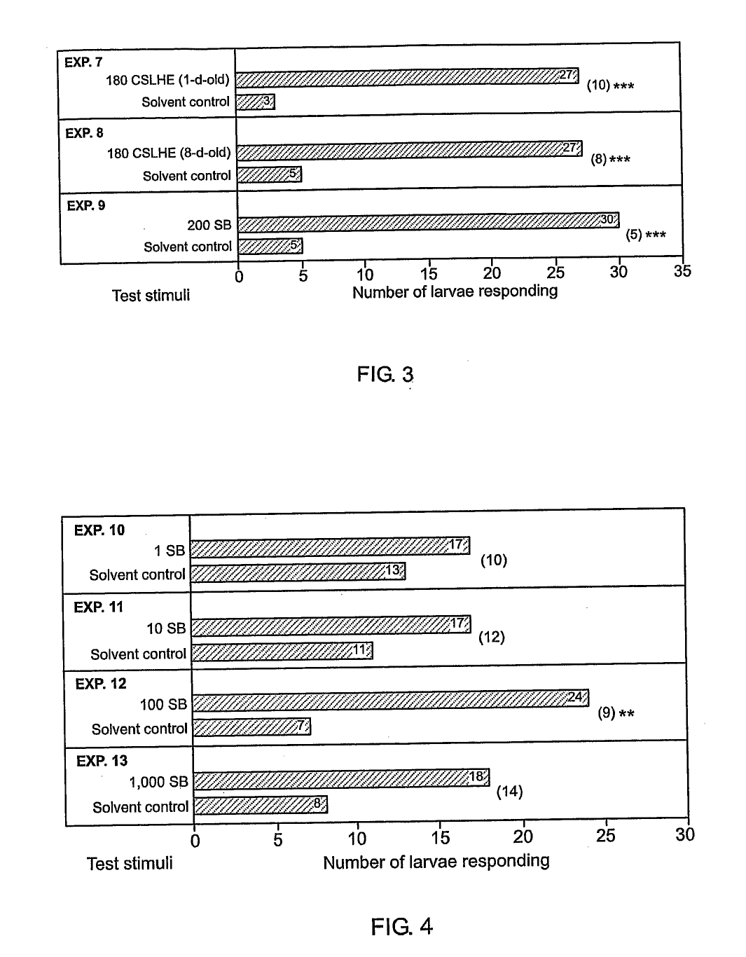

In olfactometer experiments (following the general protocol as described above), C. pomonella larvae preferred Porapak Q volatile extract of cocoon-spinning C. pomonella larvae, and a synthetic blend (SB) of 11 candidate pheromone components, over a pentane control stimulus (FIG. 3).

FIG. 3 illustrates graphical data of responses of Cydia pomonella larvae to pitfall devices baited with Porapak Q volatile extract of cocoon-spinning larvae (180 CSLHE) or a synthetic blend (SB) of 11 candidate pheromone components. Asterisks on bars indicate a significant response to a particular treatment; Chi-square goodness of fit test with Yates' correction for continuity; *** P<0.001. Note: 1) 180 CSLHE=volatiles released from 180 cocoon-spinning C. pomonella larvae during 1 hour; 2) components in SB consisted of: 1. heptanal; 2. sulcatone; 3. myrcene; 4. octanal; 5. 3-carene; 6. (+)-limonene; 7. (E)-2-octenal; 8. nonanal; 9. (E)-2-nonenal; 10. decanal; 11. geranylacetone.

Similar attractiveness of Porapak Q extract containing natural cocoon volatiles and the synthetic 11-component blend (SB) strongly suggested that all essential pheromone components were present in SB.

Of the 4 doses of SB (1, 10, 100, 1,000 CSLHE) bioassayed, 100 SB elicited the strongest response by C. pomonella larvae (FIG. 4).

FIG. 4 illustrates graphical data of responses of Cydia pomonella larvae in pitfall olfactometer experiments to 4 doses of a synthetic blend (SB) containing 11 candidate pheromone components. Bars with an asterisk indicate a significant preference for a particular treatment; Chi-square goodness of fit test with Yates' correction for continuity; ** P<0.005. Note: components in SB consisted of: 1. heptanal; 2. sulcatone; 3. myrcene; 4. octanal; 5. 3-carene; 6. (+)-limonene; 7. (E)-2-octenal; 8. nonanal; 9. (E)-2-nonenal; 10. decanal; 11. geranylacetone.

To determine the critically important components in SB, individual or groups of pheromone components were deleted and such reduced blends bioassayed in olfactometer experiments (following the protocol described above).

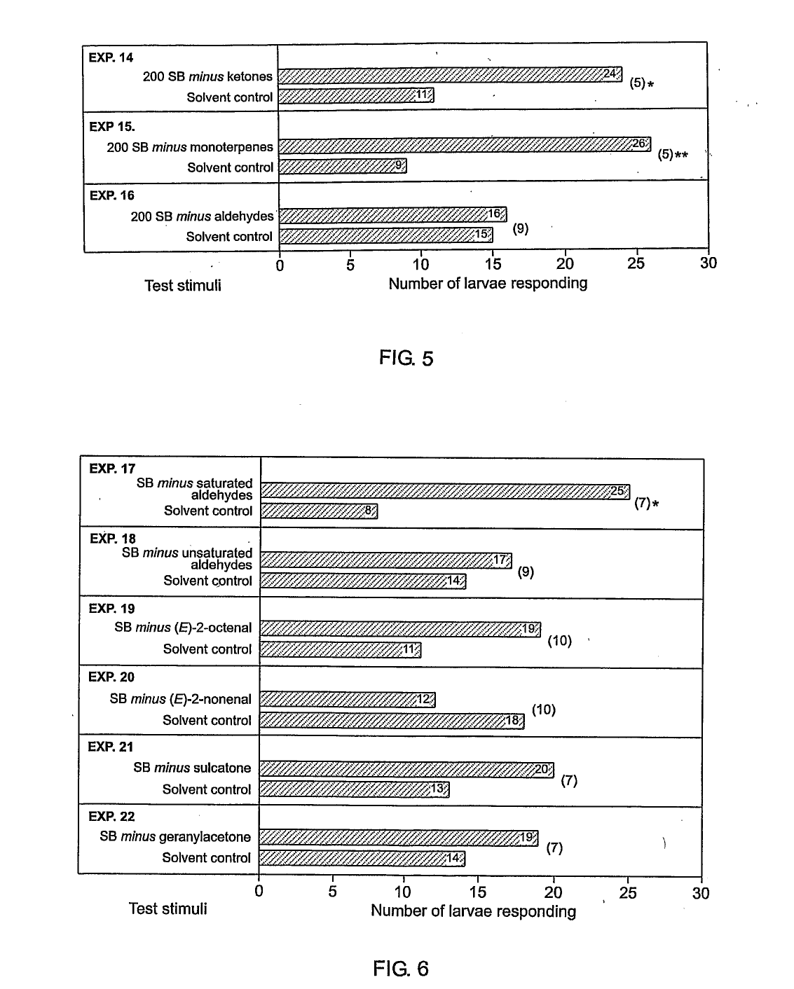

SB lacking monoterpenes [(+)-limonene, myrcene, 3-carene] or ketones (sulcatone, geranylacetone) still elicited responses from C. pomonella larvae, whereas SB lacking aldehydes [heptanal, octanal, nonanal, decanal, (E)-2-octenal, (E)-2-nonenal] was completely unattractive (FIG. 5).

FIG. 5 illustrates graphical data of responses of Cydia pomonella larvae to pitfall devices baited with synthetic blends (SB) lacking either ketones [sulcatone, geranylacetone], monoterpenes [(+)-limonene, myrcene, 3-carene], or aldehydes [heptanal, octanal, nonanal, decanal, (E)-2-octenal, (E)-2-nonenal]. Asterisks on bars indicate a significant preference for a particular treatment; Chi-square goodness of fit test with Yates' correction for continuity; * P<0.05; ** P<0.01.

SBs lacking saturated aldehydes [heptanal, octanal, nonanal, decanal] still elicited significant responses from C. pomonella larvae, whereas SBs lacking either unsaturated aldehydes [(E)-2-octenal, (E)-2-nonenal], sulcatone, or geranylacetone were as ineffective as pentane controls in eliciting response from C. pomonella larvae (FIG. 6).

FIG. 6 illustrates graphical data of responses of Cydia pomonella larvae to synthetic blends (SB) lacking either saturated aldehydes [heptanal, octanal, nonanal, decanal], unsaturated aldehydes [(E)-2-octenal, (E)-2-nonenal], or individual components. The asterisk on bars indicates a significant preference for a particular treatment; Chi-square goodness of fit test with Yates' correction for continuity; * P<0.01.

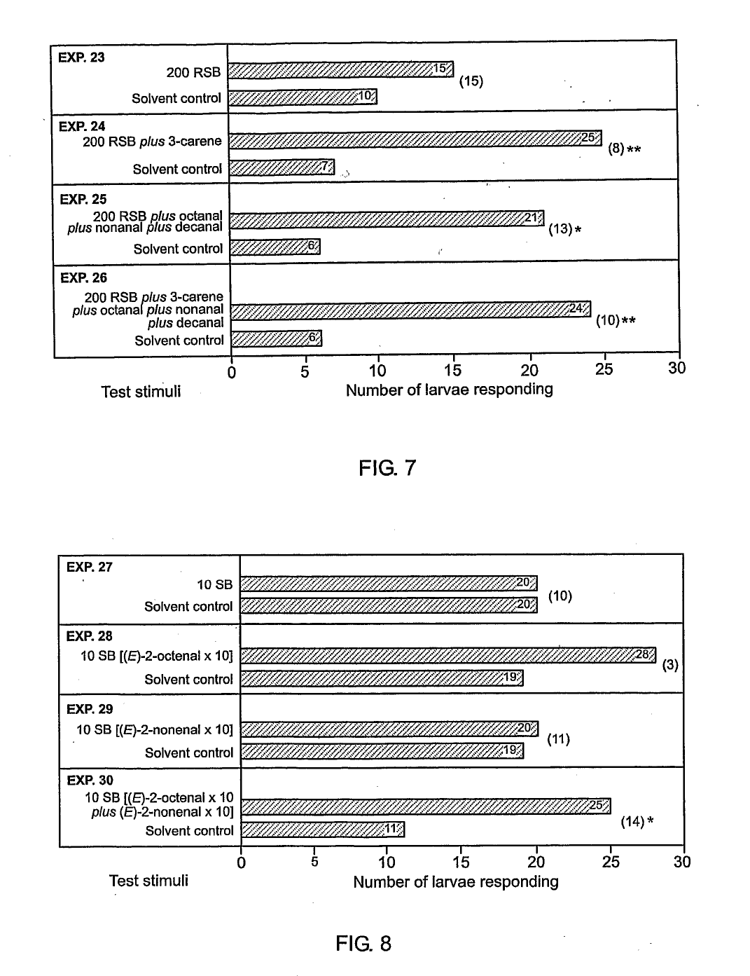

A rudimentary synthetic blend (RSB), comprising (E)-2-octenal, (E)-2-nonenal, sulcatone and geranylacetone, did not elicit a behavioural response by C. pomonella larvae. However, RSB in combination with either the monoterpene 3-carene, saturated aldehydes (octanal, nonanal, decanal), or 3-carene plus said aldehydes, induced significant attraction/arrestment by C. pomonella larvae (FIG. 7).

FIG. 7 illustrates graphical data of responses of Cydia pomonella larvae to a 4-component rudimentary synthetic blend (RSB) [(E)-2-octenal, (E)-2-nonenal, sulcatone, geranylacetone] alone or in combination with either 3-carene, saturated aldehydes [octanal, nonanal, decanal], or both. Asterisks on bars indicate a significant preference for a particular treatment; Chi-square goodness of fit test with Yates' correction for continuity; * P<0.01; ** P<0.005.

The 11-component synthetic blend (SB), when tested at the low dose of 10 cocoon-spinning larval hour equivalents and at natural compound ratios (FIG. 2), did not induce behavioural responses by C. pomonella larvae. However, a 10-fold increase of both (E)-2-octenal and (E)-2-nonenal, but not of either component singly, in SB resulted in significant attraction/arrestment of C. pomonella larvae (FIG. 8).

FIG. 8 illustrates graphical data of responses by Cydia pomonella larvae to a synthetic blend (SB) of 11 components at natural ratios (FIG. 2), or at a 10-fold increase of either or both (E)-2-octenal and (E)-2-nonenal. The asterisk indicates a significant preference for a particular treatment; Chi-square goodness of fit test with Yates' correction for continuity; * P<0.05. Note: SB was tested at 10 cocoon-spinning larval hour equivalents.

4. On-Tree Testing of Natural or Synthetic Larval Aggregation Pheromone

In on-tree experiments, maple (Acer spp.) trees (10-16 cm diameter at a height of 45 cm) were banded with corrugated cardboard strips (5 cm wide) 45 cm above ground.

Strips were divided into two halves, with test stimuli applied to the waxed, center portion of each half. For each replicate in all experiments, twenty 5^{th} instar C. pomonella larvae were released from a thin, circular platform affixed to the base of the tree's main branch crotch (˜1.50 m above ground). Experiments were initiated after dusk, and numbers of C. pomonella larvae cocooning in treatment or control halves of corrugated cardboard strips recorded 10-12 hours later.

In apple orchards (experiments 39-40), trees were banded with cardboard band prototype traps (4 in. wide) (Phero Tech, Inc., Delta, Canada) impregnated with synthetic pheromone or left unbaited. Traps comprised a continuous and central ployurethane film (˜3 cm wide) impreganted with the 8-component pheromone blend at various doses on corrugated cardboard strips. Traps were placed on tree trunks or primary branches ≧1 m above ground (≧1 ft. circumference). Experiments were conducted in Kelowna, BC between Aug. 23-27, 2004 just before mature, 5^{th} instar larvae began exiting apple fruit. Traps were collected on Oct. 8-9, 2004 and numbers of C. pomonella larvae cocooning in traps were recorded.

### EXAMPLE #1

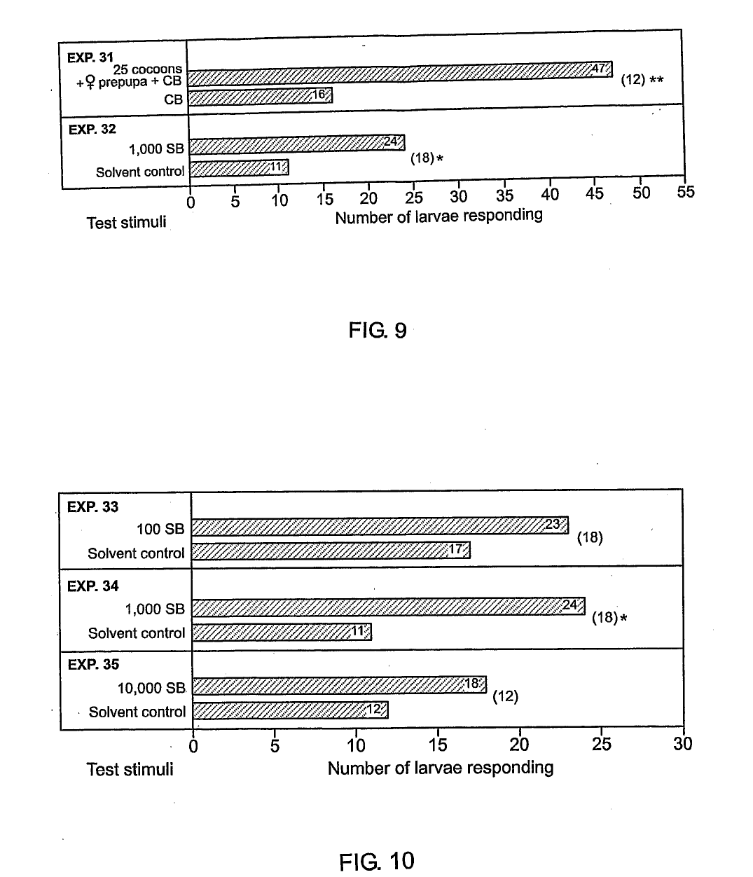

In experiment 31, significantly more C. pomonella larvae cocooned in treatment halves of corrugated cardboard strips, bearing twenty-five 1-day-old C. pomonella cocoons with female larvae/prepupae inside, than in unbaited control halves. Similarly, in experiment 32 significantly more C. pomonella larvae cocooned in halves of corrugated cardboard strips baited with a synthetic blend (SB) of pheromone components than in halves treated with a solvent control (FIG. 9).

FIG. 9 illustrates graphical data of responses by Cydia pomonella larvae in on-tree experiments 31 (12 replicates) and 32 (18 replicates) to corrugated cardboard (CB) strips. Treatment halves of CB strips carried twenty-five 1-day-old cocoons containing female C. pomonella larvae/prepupae (Exp. 31), or were baited with a synthetic blend (SB) of 11 components at 1,000 cocoon-spinning larval hour equivalents (Exp. 32). Control halves were bare (Exp. 31), or were impregnated with the equivalent amounts of solvent (Exp. 32). Asterisks indicate a significant preference for a particular stimulus; Wilcoxon paired-sample test; * P<0.01; ** P<0.005.

### EXAMPLE #2

In on-tree experiments 33-35, the synthetic blend (SB) at 1,000 cocoon-spinning larvae hour equivalents (CSLHE), but not at 100 or 10,000 CSLHE, attracted/arrested significantly more C. pomonella larvae than did a solvent control stimulus (FIG. 10).

FIG. 10 illustrates graphical data of responses by Cydia pomonella larvae in on-tree experiments 33 (18 replicates), 34 (18 replicates), and 36 (12 replicates) to corrugated cardboard (CB) strips impregnated with a synthetic blend (SB) of 11 components at 100, 1,000, or 10,000 cocoon spinning larvae hour equivalents, or a solvent control. The asterisk indicates a significant preference for a particular stimulus; Wilcoxon paired-sample test; * P<0.01.

### EXAMPLE #3

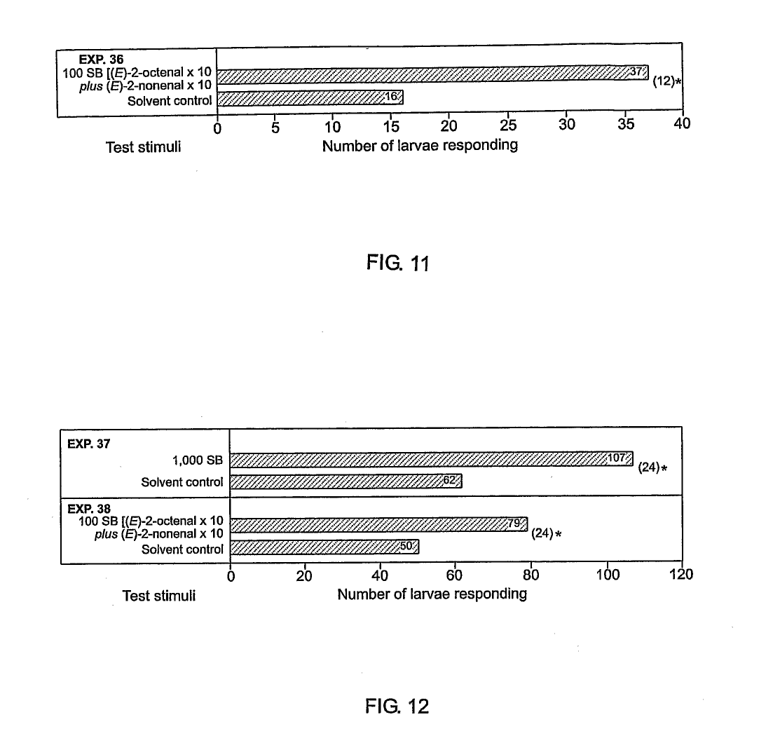

In on-tree experiment 36, significantly more C. pomonella larvae cocooned in halves of corrugated cardboard (CB) strips impregnated with a synthetic blend (SB) of 11 components, tested at 100 cocoon-spinning larval hour equivalents with increased amounts (×10) of (E)-2-octenal and (E)-2-nonenal, than on halves impregnated with a solvent control (FIG. 11).

FIG. 11 illustrates graphical data of responses by Cydia pomonella larvae in on-tree experiment 36 (12 replicates) to corrugated cardboard (CB) strips impregnated with a synthetic blend (SB) of pheromone components or a solvent control. The asterisk indicates a significant preference for a particular stimulus; Wilcoxon paired-sample test; * P<0.02. Note: SB was tested at 100 cocoon-spinning larval hour equivalents with increased amounts (×10) of (E)-2-octenal and (E)-2-nonenal.

### EXAMPLE #4

In concurrently run on-tree experiments 37 and 38, significantly more C. pomonella larvae cocooned in halves of corrugated cardboard strips impregnated with a synthetic blend (SB) of 11 components at doses of 1,000 cocoon-spinning larval hour equivalents (CSLHE), or a modified synthetic blend at 100 CSLHE, than in halves impregnated with the equivalent amount of a solvent (pentane) control (FIG. 12).

FIG. 12 illustrates graphical data of responses by Cydia pomonella larvae in concurrently run on-tree experiments 37 (24 replicates) and 38 (24 replicates) to halves of corrugated cardboard (CB) strips impregnated with synthetic blends (SB) of 11 components. An asterisk indicates a significant preference for a particular stimulus; Wilcoxon paired-sample test; * P<0.005. Note: In experiment 38, the SB at 100 cocoon-spinning larvae hour equivalents contained increased amounts (×10) of (E)-2-octenal and (E)-2-nonenal.

### EXAMPLE #5

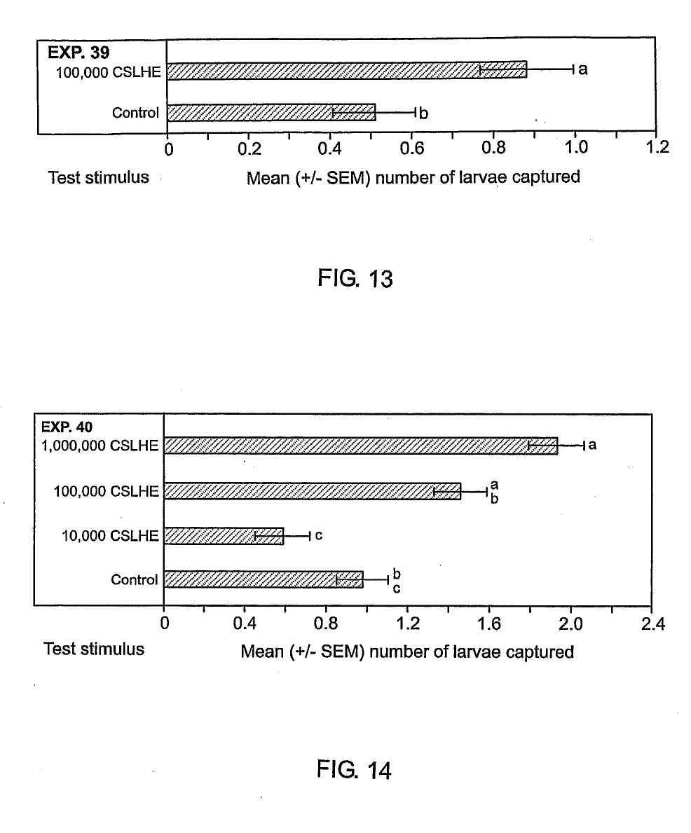

In experiment 39 in an apple orchard, the mean number of Cydia pomonella larvae that cocooned in corrugated cardboard traps affixed to tree trunks and baited with the 8-component pheromone blend at 10,000 cocoon-spinning larvae hour equivalents (CSLHE) was significantly greater than the mean number of larvae that cocooned in traps left unbaited (FIG. 13).

FIG. 13 illustrates graphical data obtained in an apple orchard in experiment 39 of mean (±SEM) numbers of Cydia pomonella larvae captured in cardboard band prototype traps impregnated with the 8-component synthetic blend (SB) of pheromone or left as unbaited controls. Bars with different letter superscripts indicate statistical significance between treatments; Student's t; P<0.02. Note: components in SB consisted of: 1. sulcatone; 2. octanal; 3. 3-carene; 4. (E)-2-octenal; 5. nonanal; 6. (E)-2-nonenal; 7. decanal; 8. geranylacetone.

### EXAMPLE #6

In experiment 40 in an apple orchard, the mean number of Cydia pomonella larvae that cocooned in traps baited with the 8-component pheromone blend at 100,000 cocoon-spinning larvae hour equivalents (CSLHE) was significantly greater than the mean number of larvae that cocooned in traps baited with 1,000 CSLHE or in traps left unbaited. Moreover traps baited with 10,000 CSLHE captured on average significantly more larvae than traps baited with 1,000 CSLHE (FIG. 14).

FIG. 14 illustrates graphical data obtained in an apple orchard in experiment 40 of mean (±SEM) numbers of Cydia pomonella larvae captured in cardboard band prototype traps impregnated with various doses of the 8-component synthetic blend (SB) of pheromone. Bars with different letter superscripts indicate statistical significance between treatments; ANOVA with Student's t MCP; P<0.005. Note: components in SB consisted of: 1. sulcatone; 2. octanal; 3. 3-carene; 4. (E)-2-octenal; 5. nonanal; 6. (E)-2-nonenal; 7. decanal; 8. geranylacetone.

### REFERENCES

U.S. Patent Documents

Henrick, C. A. and Siddall, J. B. 3/1976. Synthesis of codling moth attractant. U.S. Pat. No. 3,943,157.
Klein, U., Neumann, U., Mackenroth, W., Renz, G., Krieg, W., Mackenroth, C., Buschman, E., DeKramer, J. J., and Milli, R. 2/1997. Preparation, intermediates for the preparation and the use of a mixture of dodecadienol isomers. U.S. Pat. No. 5,599,848.
Light, D. M., Henrick, C. A. 3/2003. Bisexual attractants, aggregants, and arrestants for adults and larvae of codling moth and other species of lepidoptera. U.S. Pat. No. 6,528,049.
Löfqvist, J., Bengtsson, M., and Witzgall, P. 5/2002. Combating pest insects. U.S. Pat. No. 6,395,775.
Yamamoto, A., Ogawa, K., and Nagura, S. 3/1988. Method for concurrently emitting vapors of sex pheromones of different insects. U.S. Pat. No. 4,734,281.
   Other Publications
Arm, H., Städler, E., and Rauscher, S. 1975. The electroantennographic detector—a selective and sensitive tool in the gas chromatographic analysis of insect pheromones. Zeitschrift fur Naturforschung 30: 722-25.
Duthie, B., Gries, G., Gries, R., Krupke, C. and Derksen, S. 2003. Does pheromone based aggregation of codling moth larvae help procure future mates? Journal of Chemical Ecology 29: 425-436.
Jumean, Z., Gries, R., Unruh, T., Rowland, E., Gries, G. 2005. Identification of the larval aggregation pheromone of codling moth, Cydia pomonella. Journal of Chemical Ecology In press.
Jumean, Z., Rowland, E., Judd, G J R., Gries, G. 2004a. Male and female Cydia pomonella (Lepidoptera: Olethreutidae) larvae produce and respond to aggregation pheromone. The Canadian Entomologist 136: 871-873.
Jumean, Z., Unruh, T., Gries, R., Gries, G. 2004b. Mastrus ridibundus parasitoids eavesdrop on cocoon-spinning codling moth, Cydia pomonella, larvae. Naturwissenschaften 92: 20-25.

What is claimed is:

1. A composition of chemicals for manipulating the behaviour of Cydia pomonella larvae, said composition comprising two or more chemicals in all possible combinations and ratios selected from the group consisting of: 1) heptanal; 2) 6-methyl-5-hepten-2-one (sulcatone); 3) myrcene; 4) octanal; 5) 3-carene; 6) (+)-limonene; 7) (E)-2-octenal; 8) nonanal; 9) (E)-2-nonenal; 10) decanal; 11) geranylacetone.

2. A composition as claimed in claim 1 wherein the composition is combined with non-pheromonal attractants of larvae.

3. A composition as claimed in claim 1 wherein the composition is contained in, or released from, slow release devices.

4. A composition as claimed in claim 1 wherein the composition is contained in, and released from, an apparatus or matrix that provides suitable pupation sites for attracted Cydia pomonella larvae.

5. A method for attracting Cydia pomonella larvae into an apparatus, said apparatus containing a composition comprising two or more chemicals in all possible combinations and ratios selected from the group consisting of: 1) heptanal; 2) sulcatone; 3) myrcene; 4) octanal; 5) 3-carene; 6) (+)-limonene; 7) (E)-2-octenal; 8) nonanal; 9) (E)-2-nonenal; 10) decanal; 11) geranylacetone.

6. A method as claimed in claim 5 wherein the apparatus is corrugated cardboard.

7. A method as claimed in claim 5 wherein the apparatus is a matrix that polymerizes and hardens after application.

8. A method as claimed in claim 5 wherein the apparatus or matrix contains an insect-killing agent.

9. A method as claimed in claim 8 wherein the killing agent is a chemical insecticide.

10. A method as claimed in claim 8 wherein the killing agent is a biological insecticide.

11. A bait and apparatus or matrix for deployment in an area containing fruit or nut crops, said bait incorporating a composition of chemicals as claimed in claim 1, and said apparatus or matrix providing suitable pupation sites for Cydia pomonella larvae.

12. An apparatus or matrix as claimed in claim 11 wherein the apparatus or matrix is deployed directly to apple, pear, walnut, or other fruit or nut trees.

13. An apparatus or matrix as claimed in claim 11 wherein the apparatus is deployed directly to apple, pear, walnut, or other fruit or nut storage bins.

14. A method of manipulating the behaviour of Cydia pomonella larvae through attraction or arrestment which comprises exposing larvae to two or more chemicals as claimed in claim 1.

15. A method of diagnosing whether protection of apple, pear, walnut, or other fruit or nut crops is warranted, comprising exposing the fruit or nut crop to a composition as claimed in claim 1, and determining whether Cydia pomonella larvae are attracted by the composition.

16. A method of protecting apple, pear, walnut, or other fruit or nut crops from attack by Cydia pomonella larvae by deploying proximate to fruit or nut crops a composition as claimed in claim 1.

17. A composition as claimed in claim 1 wherein the composition is used in combination with tactics aimed at controlling adult male and/or female Cydia pomonella.

18. A composition as claimed in claim 1 wherein the two or more chemicals are combined with a carrier.
